(19) United States
(12) Patent Application Publication
(10) Pub. No.: US 2008/0166992 A1
(43) Pub. Date: Jul. 10, 2008

(54) MOBILE EMERGENCY ALERT SYSTEM

(76) Inventors: Camillo Ricordi, Miami, FL (US); Steven Sikes, Miami, FL (US); Stephen William Anthony Sanders, Mill Valley, CA (US)

Correspondence Address: HOLLAND & KNIGHT LLP, 10 ST. JAMES AVENUE, 11th Floor, BOSTON, MA, 02116-3889, US

(21) Appl. No.: 11/938,057

(22) Filed: Nov. 9, 2007

Related U.S. Application Data
(60) Provisional application No. 60/884,219, filed on Jan. 10, 2007.

(51) Int. Cl. H04M 11/04; H04M 3/42; H04Q 7/00

(52) U.S. Cl. 455/404.2; 340/539.13; 455/416

(57) ABSTRACT

A health-related emergency mobile alert system to facilitate communication, care and intervention during critical events. The system communicates with medical monitors, which measure and collect a subject's physiological data and vital signs information. A service provider maintains a database with the subject's medical records and an emergency contact list. When a critical event is detected, a two-way mobile communication device that is configured to communicate with the medical monitor transmits the physiological data and location coordinates of the subject to the service provider, and a conference call with members of the emergency contact list is initiated to help facilitate aid to the subject. The two-way mobile communication device may include a speaker and GPS technology. It may also include self-activating features wherein pre-recorded messages conveying potential dangers are transmitted to the subject when the subject's physiological data and vital signs reflect precarious levels.

### CROSS REFERENCE TO RELATED APPLICATIONS

This application claims priority under 35 U.S.C §119(e) to U.S. Provisional Application Serial No. 60/884,219, entitled “A System and Apparatus for Alerting, Location, Tracking, Messaging and Intervention (ALTMI),” filed Jan. 10, 2007, the entire contents of which are hereby incorporated by reference.

### FIELD OF INVENTION

The present invention relates to health-related monitoring and more specifically to a health-related mobile emergency alert system.

### BACKGROUND

Many types of critical events, such as medical, health and personal emergencies, may be alleviated with prompt medical attention and rescue intervention. For example, subjects having hypoglycemic episodes may simply need a glass of orange juice or a glucagon tablet to regulate their blood sugar. In children or the elderly, the time for response may be critical, yet these subjects may not be able to provide the needed assistance to themselves or be cognizant or even in the position to ask someone for help due to their medical conditions or the severity of the critical event. Further, because the onset of many emergency medical conditions is gradual, the subjects and those in the vicinity of the subjects experiencing the critical event may not even recognize the imminent danger and potential crisis. Similarly, some subjects may mistake a critical event for some less urgent condition. For example, many subjects mistake a heart attack as heartburn or indigestion. Timely intervention can prevent or reverse a potentially life-threatening event. For example, untreated hypoglycemia can result in a loss in the functioning of motor and cognitive skills, central nervous system damage, and even death. Similarly, for someone experiencing a critical cardiac event or episode, there is limited time, usually only minutes, to provide assistance. Someone experiencing breathing problems, for example, relating to asthma, COPD, or emphysema, typically requires immediate attention.

Further, because some medical conditions like hypoglycemia may result in a loss in functioning of motor and cognitive skills, a subject may appear inebriated, rather than having a critical event. Such an appearance may diminish the possibility that someone in a public setting would render assistance to the subject. For example, subjects having a hypoglycemic episode have been pulled over by the police after police suspected these subjects were driving while intoxicated or under the influence because their vehicles may have been weaving. Even after the subjects are pulled over, the police have little or no way of knowing that the individuals are having an emergency event and often mistake the subjects for being drunk and disorderly. Further, if the subjects are not pulled over, they may become a danger to themselves and others on the road because of their impaired motor skills and judgment brought on by the critical episode.

Also, many health emergencies go untreated until permanent physical damage or death occurs, even when someone is in the next room or neighborhood because that person was not aware or alerted to the critical event. Further, if an individual was to recognize that a subject needed assistance, the individual may not know how to care for the subject in distress. Further still, emergency personnel may take several minutes to assess the critical event before administering the correct or appropriate treatment. Each delay may lead to permanent physical damage, unnecessary suffering, extreme trauma or even death.

### SUMMARY

The present invention provides a health-related mobile emergency alert system that sends messages and communication alerts to a plurality of emergency contacts to help render assistance quickly, by opening a conference call with the emergency contacts and the subject over a speaker, or by instructing the emergency contacts to render help or to facilitate intervention.

In general, in one aspect, the invention features a health-related mobile emergency alert system that may include a medical monitor to measure and collect a subject's physiological data related to a particular medical condition, such as diabetes, COPD, emphysema, cardiac disease, epilepsy, stroke, and asthma, among many other chronic conditions. A service provider has a database that includes the subject's medical records and an emergency contact list, which includes at least one emergency contact. When a critical event is detected, a two-way mobile communication device, which interfaces with the medical monitor, transmits the physiological data to the service provider, and receives information from the service provider and the emergency contacts through a conference line.

In embodiments, the two-way mobile communication device also includes a speaker to facilitate the transmission of remote assistance or telemedicine for delivery over multiple lines via a conference call. In some embodiments, when the situation or event does not warrant live person assistance, information and guidance can be delivered via pre-recorded messages to the subject and a plurality of the emergency contacts, for example, sending preliminary warnings and instructions to mitigate a potentially dangerous situation or critical event involving the subject.

In certain embodiments, the two-way mobile communication device may be a mobile telephone configured to communicate with the medical monitor. In other embodiments, the two-way mobile communication device may be a mobile telephone and a proxy device. The proxy device would be configured to facilitate communication between the mobile telephone and the medical monitor.

In various embodiments, the emergency contact may be a representative of the service provider, a telecare provider, emergency care personnel, a caregiver, a colleague, a travel partner, a spouse, a child, a neighbor, or a friend of the subject. In general, the emergency contact list may consist of a plurality of emergency contacts. The initial contact may be the subject, or if there is no response when communication is transmitted to the subject, the system will send out messaging alerts to the emergency contacts. In some embodiments, messages to the emergency contacts may be sent to select emergency contacts based on specific criteria, including but not limited to an updated priority contact list, the time of day, or the location and proximity of the selected emergency contacts to the subject having the critical event.

In certain embodiments, the subject's medical records and emergency contact list may be modified by the subject. In various embodiments, the subject may modify the subject's medical records and emergency contact list through an internet portal, mobile device, or call-in center after authenticating the identity of the subject. In certain embodiments, the two-way mobile communication device also includes the ability to transmit a location coordinate of the subject experiencing the critical event. The location coordinate of the subject may be identified by global positioning system (“GPS”) or mobile telephone triangulation.

In various embodiments, the health-related mobile emergency alert system may monitor hypoglycemia, hyperglycemia, cardiac arrest, high blood pressure, stroke, heart rate, oxygen levels, falls, arrhythmia, ventricular hypertrophy, tachycardia, electrolytes imbalance, irregular neural activity, among a plurality of other health-related conditions or vital signs.

The database architecture may comprise algorithms, which enable pattern recognition and interactive evaluation. Utilizing database records enables a telecare provider to predict potential events and activities and to signal and transmit alerts to selected contacts based on the most effective course to facilitate assistance. For example, based on the subjects' prior emergency events, such as falls, hypoglycemic episodes, disorientation, or inability to breathe with regularity, among a plurality of critical health-related episodes, the telecare provider may initiate messaging using prior information, medical records, or compatibility of the emergency contacts, including but not limited to priority or preference in the emergency contact list, and proximity of the contact to the subject at the time of the critical event. In addition, this data mining architecture can identify and evaluate potential scenarios and predictive outcomes. Pre-recorded messages and alerts can also be transmitted, as warnings and guidance, to the subjects and emergency contacts when the medical monitors measure a plurality of vital signs, including but not limited to blood sugar, oxygen levels, blood pressure, heart rate, or body temperature, that may indicate the onset of a potential critical event, thereby initiating a course of action before the subject reaches the critical event.

The telecare provider may access the database of the service provider in any manner. For example, the telecare provider may access the subjects' medical records and emergency contacts through the Internet or via secure computer global or wireless networks. Further, the telecare provider may access the subject's medical records and emergency contacts through a call center of the service provider, through which the telecare provider would utilize a representative of the service provider to access the subject's medical records and communicate with the emergency contacts.

In general, and in still another aspect, the invention features a method of rendering aid to a subject by monitoring and collecting a subject's physiological data related to a medical condition and transmitting this information and location coordinates to a service provider that maintains a database comprising the subject's medical records and emergency contact list. When a critical event is detected, a conference call is initiated between the subject and at least one emergency contact from the emergency contact list, or when the subject cannot or is unable to communicate, messaging and communication will be transmitted to a plurality of selected contacts. Further, a tracking component and aerial mapping feature may provide a visual representation of the subject and respective location coordinates as well as the real-time location coordinates of contacts and emergency care providers if available. The location coordinates of the subject and the contacts may be provided by a global positioning system or mobile telephone triangulation.

In various embodiments, a two-way mobile communication device having a speaker transmits the physiological data and location coordinates of the subject to a service provider. The conference call may be broadcast over the speaker.

In various embodiments, the emergency contact list may include emergency contacts including a representative of the service provider, a telecare provider, emergency care personnel, a caregiver, a colleague, a travel partner, a spouse, a child, a neighbor or a friend of the subject. In certain embodiments, the subject's medical records and emergency contact list may be modified by the subject. For example, the subject's medical records and emergency contact list may be modified through an internet portal, mobile device, or call-in center.

The invention can be implemented to realize one or more of the following advantages. Once a critical event is detected, the subject and a plurality of emergency contacts are contacted to potentially render assistance to the subject. Moreover, the subject in distress, who may be experiencing a critical event or is disoriented, is located utilizing, for example, GPS technology. Because several contacts are able to communicate with each other through any one of a variety of messaging technologies, including but not limited to speech, text, video and audio, along with a telecare provider and the subject on a conference call, an emergency contact close to the individual may be identified and asked to render medical care guided by the telecare provider and/or other emergency contact, thereby providing the quickest assistance.

However, the subjects also are able to communicate with the emergency contacts in the event that no assistance is needed, such as when the subjects can administer or have administered care to themselves. Further, if the subject does not respond, and none of the emergency contacts are nearby, emergency service personnel, such as EMTs, police and firemen, may be contacted and dispatched to provide aid to the subject. Also, the health-related mobile emergency alert system may call out over the speaker, or through an alarm, utilizing visualization signals or a live voice, to alert individuals in the vicinity of the subject that a critical event is occurring and to request someone to either facilitate assistance to the subject, with the aid and guidance of the telecare provider or remote emergency contact, or at least, to make sure the subject is not vulnerable to further injury or distress depending on several factors, including but not limited to the location and the severity of the critical event.

Further still, the mobile emergency alert system may call out to the subjects and the emergency contacts thereby potentially enabling elderly subjects to live on their own with greater security. For example, if an elderly subject experiences a fall or critical event inside or outside the home-based environment, the subject may press a button on the two-way mobile communication device to transmit a distress call to the service provider and to initiate the conference call with the emergency contacts. The system also enables greater support for children, who may be disoriented, lost or experiencing a critical health-related event. For example, for a child experiencing a hypoglycemic episode occurring during the night, an immediate alert may be sent to the subject to awaken and inform the subject that the risk of a severe hypoglycemic event is possible, which enables the subject to take immediate corrective action. In the absence of a response from the subject, the service provider initiates immediate communication, including but not limited to calls, text, and instant messaging, to selected emergency contacts (e.g., family members, friends and neighbors) and a telecare provider.

Similarly, the mobile alert system may be used with infants and children who have pediatric hypoglycemia, which causes thousands of deaths each year worldwide. For example, if an infant using the mobile alert system experiences a hypoglycemic episode during the night, an immediate call to the infant's parents and a telecare provider or personnel at the service provider is initiated, which will alert the parents of their child's critical event and enable them to render the most optimum assistance.

The mobile emergency alert system may also alert police, other law enforcement and emergency care responders that a subject is acting erratically or behaving abnormally due to a health-related critical event, rather than due to excessive alcohol, drug use, or a non-health related critical event. Thus, if the subject is driving, the police or highway patrol troopers may intervene to escort or guide the subject from the road and render medical assistance. If the police are already on the scene, the emergency contacts on the speaker may alert the police to the subject's medical condition, either through a pre-recorded message or live support from a telecare provider.

The subject's medical database can be readily updated by the subject through an internet portal, a mobile device or a call center. This feature enables the subject to update the emergency contact list as needed. For example, if the subjects are traveling on vacation or for professional reasons, they may modify the emergency contact list to include individuals they are visiting or local emergency personnel. Further, the subjects may structure the emergency contact list to include daytime emergency contacts, for example co-workers, and nighttime emergency contacts, such as neighbors. Also, the subjects may modify their medical database to quickly add new or temporary medications, so the telecare provider has the most up-to-date information for the subject.

Further, the two-way communication device may be configured to enable a subject to locate and communicate with other subjects using the mobile emergency alert system. For example, the mobile emergency alert system may locate other subjects in the area based on proximity, compatibility, and preferences, such as similar medical conditions, gender, and/or age.

Further still, because the database architecture also may comprise a proximity algorithm based on a subject's prior travels and daily navigations, selected contacts, including emergency care responders in the vicinity, may receive messages and alerts that a subject, while not having a critical event yet, is in danger of experiencing a critical event, based on a plurality of factors, including but not limited to heart rate, blood sugar, oxygen levels, or disorientation, to prepare these contacts for possible intervention. Once a subject has a diminished propensity to remain at risk of having a potential critical event, pre-recorded, automatic messaging and alerts may be transmitted and delivered to these contacts.

Also, the initial stage of the mobile emergency alert system may deliver an automatic message to the subjects through the speaker, alerting them that there is a physiological parameter moving towards a potential critical event. If there is no response from the subject, the personalized emergency system will transmit alerts and messages to the selected and appropriate emergency contacts and emergency care providers in the vicinity, such as EMTs and police. Other features and advantages of the invention are apparent from the following description, and from the claims.

### BRIEF DESCRIPTION OF THE DRAWINGS

FIG. 1 is a block diagram of an exemplary mobile emergency alert system.

FIG. 2 is an overview flow chart of an exemplary process carried out by the mobile emergency alert system.

FIG. 3 is a flow chart of an exemplary process of setting up an account for the mobile emergency alert system.

FIG. 4 is a flow chart of another exemplary process carried out by the mobile emergency alert system.

FIG. 5 is a flow chart of another exemplary process carried out by the mobile emergency alert system.

FIG. 6 is a flow chart of another exemplary process carried out by the mobile emergency alert system.

FIG. 7 is a flow chart of another exemplary process carried out by the mobile emergency alert system.

FIG. 8 is a flow chart of another exemplary process carried out by the mobile emergency alert system.

Like reference numbers and designations in the various drawings indicate like elements.

### DETAILED DESCRIPTION

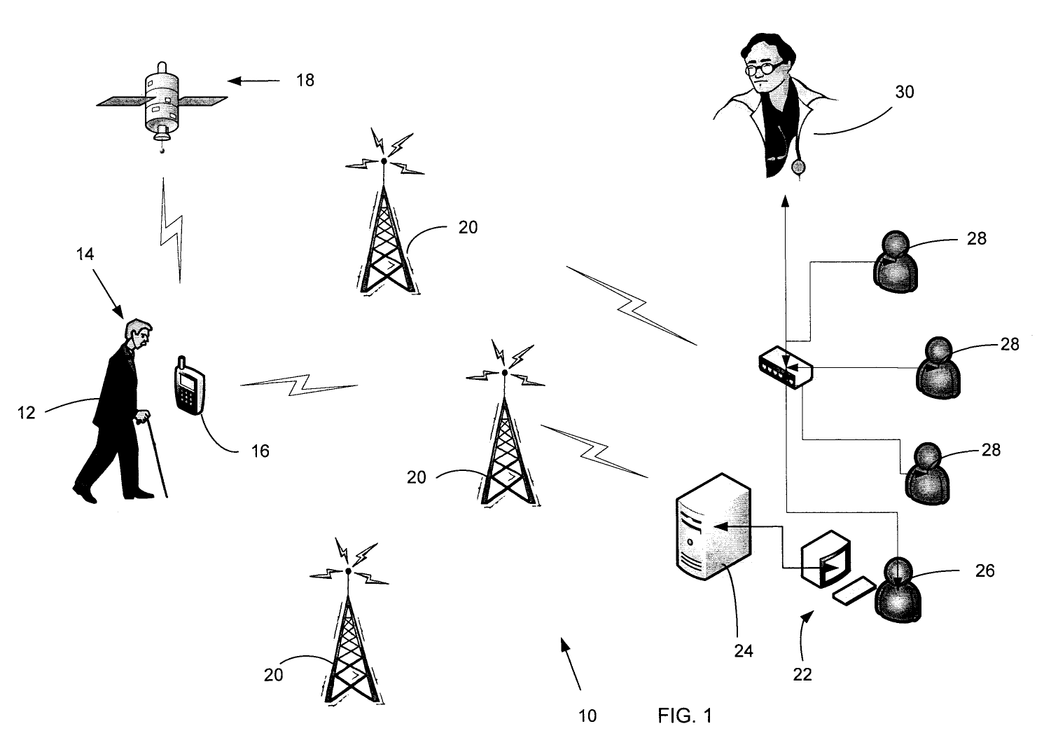

As shown in FIG. 1, the mobile emergency alert system 10 includes a medical monitor 12 worn by a subject 14, for example, a patient, an athlete, or any other user of the mobile emergency alert system 10. The medical monitor 12 measures the subject's desired physical attribute, for example blood sugar levels, and communicates any abnormal or dangerous levels to an Alerting, Locating, Tracking, Messaging and Intervention Device (“ALTMI”) 16 carried by the subject 14. The ALTMI 16 is a two-way mobile communication device (i.e., capable of sending and receiving information and/or data), such as a mobile telephone, configured to communicate with the medical monitor 12. The medical monitor 12 may be any type of medical monitor or sensor used to measure physiological data. The medical monitor 12 and ALTMI 16 may communicate by wireless technology, such as Bluetooth. The ALTMI 16 may also be capable of being located by a global positioning system (“GPS”) 18 or by triangulation from various cellular towers 20.

The ALTMI 16 may be a separate device, such as the mobile telephone described above, or it may be an integral part of the medical monitor 12. Further, the ALTMI 16 may be two separate components configured to communicate with the medical monitor 12. For example, the ALTMI 16 may be a two-way mobile communication device, such as the mobile telephone, and a proxy device to enable the two-way mobile communication device to communicate with the medical monitor 12. In such a configuration, the proxy device works as a translator between the two-way mobile communication device and the medical monitor 12. The proxy device enables greater flexibility to use, for example, any mobile telephone with any medical monitor 12 by programming the proxy device to communicate with both.

The ALTMI 16 sends information from the medical monitor 12, for example physical parameters measured by the medical monitor 12, and the ALTMI 16, such as location from the GPS 18, via the cellular towers 20 to a service provider 22 that houses the subject's medical database 24. The subject's medical database 24 includes the subject's medical records and emergency contact list. The subject's medical database 24 may also reside on the ALTMI 16. When a critical event is detected, the service provider 22 opens a conference call and initiates a call with several individuals, which may include a representative of the service provider 26, emergency contacts 28 and a telecare provider 30, such as a physician, as is more fully explained below.

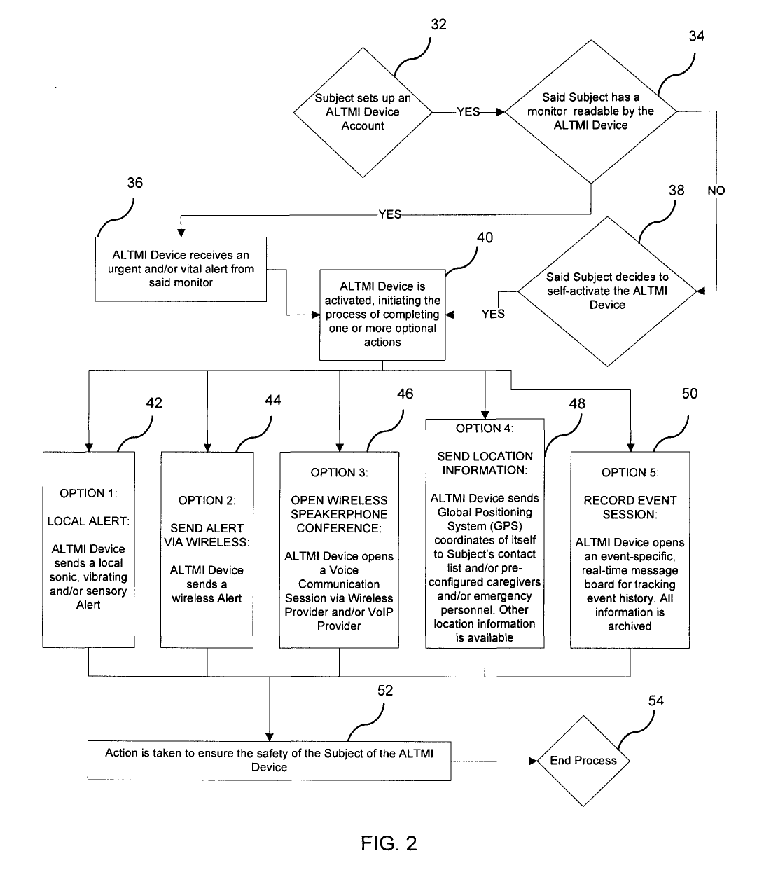

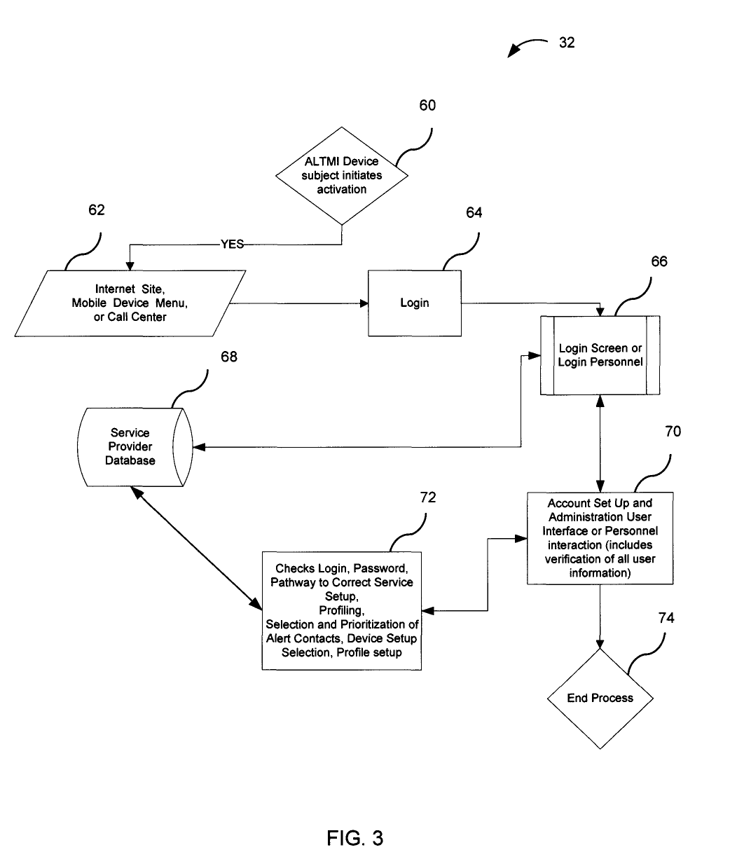

Referring now to FIGS. 2 and 3, a subject 14 sets up an ALTMI account (32) by initiating the activation (60). The ALTMI account may be initiated through an Internet portal, a mobile device (e.g., mobile telephone or PDA), or a call-in center 62, which will require the subject 14 to login (64). The login screen or login personnel 66 will share information with a service provider database 68. The account set up and administration user interface 70 will enable the subject 14 to check login, passwords, determine a pathway to set up correct protocol service, set up emergency contacts 28, device setup selection, and profile set up. (72). The emergency contact list may include anyone, but preferably, includes at least a physician, a representative of the service provider, a telecare provider, emergency care personnel, a caregiver, a colleague, a travel partner, a spouse, a child, a family member, a neighbor, and/or a friend who is nearby.

The subject 14 may also modify his account at any time through the internet portal, mobile device, or call-in center 62. For example, the subject 14 may modify the emergency contact 28 list. Such modification may be necessary when an emergency contact 28 moves, such as a neighbor, or when the subject 14 goes on vacation. When the subject 14 goes on vacation, the subject 14 may temporarily modify the subject's emergency contact 28 list to include people the subject is visiting or alerting, or local emergency personnel. Further, subjects 14 may see more than one physician, particularly elderly subjects 14. If one physician prescribes a new medication, the subject 14 may update the subject's medical records immediately without having to wait for the medical records to make their way to the service provider 22 from the physician.

As shown in FIG. 2, in one exemplary process carried out by the mobile emergency alert system 10, when the medical monitor 12 indicates that the subject's 14 measured physical attributes are within a predetermined, emergency condition, the medical monitor 12 will send a signal. If the subject 14 has a medical monitor 12 that is readable by the ALTMI 16 (34), then the ALTMI 16 may receive an urgent and/or vital alert from the medical monitor 12 (36). If the medical monitor 12 is not readable by the ALTMI 16, then the subject 14 may self-activate the ALTMI 16 (38). Once the ALTMI 16 is activated, the ALTMI 16 will initiate one or more optional actions (40). Option action one (42) may include a local alert in which the ALTMI 16 sends a local audible, vibrating and/or other sensory alert. Option action two (44) may include the ALTMI 16 sending a wireless alert. Option action three (46) may include opening a wireless speakerphone conference call in which the ALTMI 16 opens a voice communication session via a wireless provider or Voice over Internet Protocol (“VoIP). This initiation of the conference call may be accomplished automatically or by a service provider representative. Option action four (48) may include sending location information, such as GPS coordinates, from the ALTMI 16 to a representative of the service provider 26, the subject's emergency contacts 28 and/or the telecare provider 30. Option action five (50) may include recording data from the medical monitor 12 to track and monitor the critical event. To record the data, the ALTMI 16 may open an event-specific real-time message board to track the critical event history and archive the data. After one or more of the option actions occur, action is taken to ensure the safety of the subject 14 (52), and the process is thereafter ended (54).

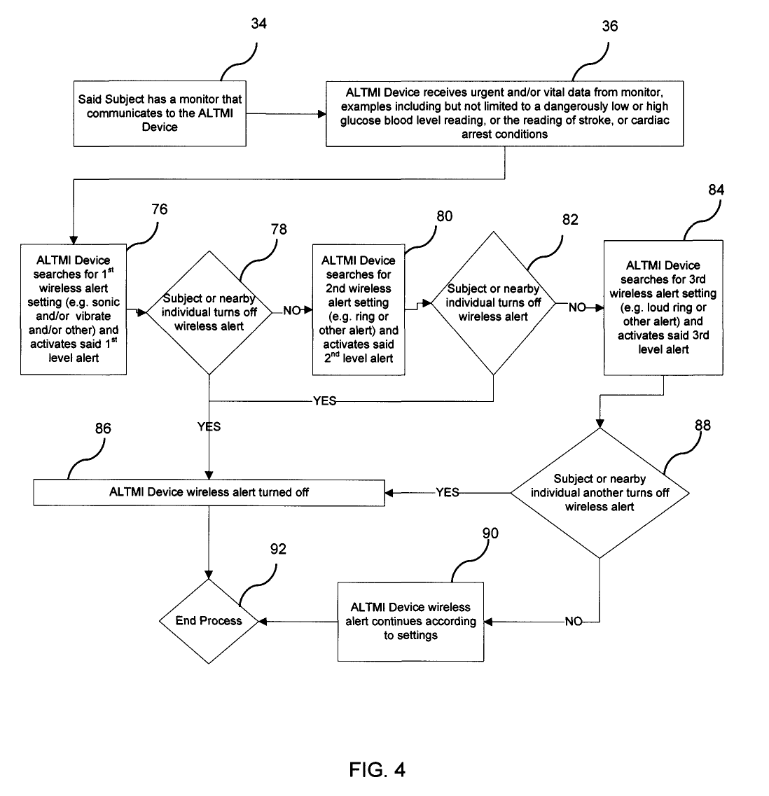

Referring now to FIG. 4, in another exemplary process carried out by the mobile emergency alert system, the subject 14 has a medical monitor 12 that communicates with the ALTMI 16 (34), and the ALTMI 16 may receive an urgent and/or vital alert from the medical monitor 12 (36). The ALTMI 16 searches for a first wireless setting, which may include an audible, vibrating and/or other sensory alert, and activates the first wireless alert (76). The subject 14 or a nearby individual may turn off the wireless alert or speaker on the mobile communication device (78). If the ALTMI 16 wireless alert is turned off (86), then the process is ended (92). If the ALTMI 16 wireless alert is not turned off, then the ALTMI 16 searches for a second wireless alert setting and activates the second wireless alert (80). Again, the subject 14 or a nearby individual may turn off the wireless alert (82). If the ALTMI 16 wireless alert is turned off (86), then the process is ended (92). If the ALTMI 16 wireless alert is not turned off, then the ALTMI 16 searches for a third wireless alert setting, such as a loud audible alert, and activates the third wireless alert (84). Again, the subject 14 or a nearby individual may turn off the wireless alert (88). If the ALTMI 16 wireless alert is turned off (86), then the process is ended (92). If the ALTMI 16 wireless alert is not turned off, then the ALTMI 16 wireless alert continues, according to its settings (90).

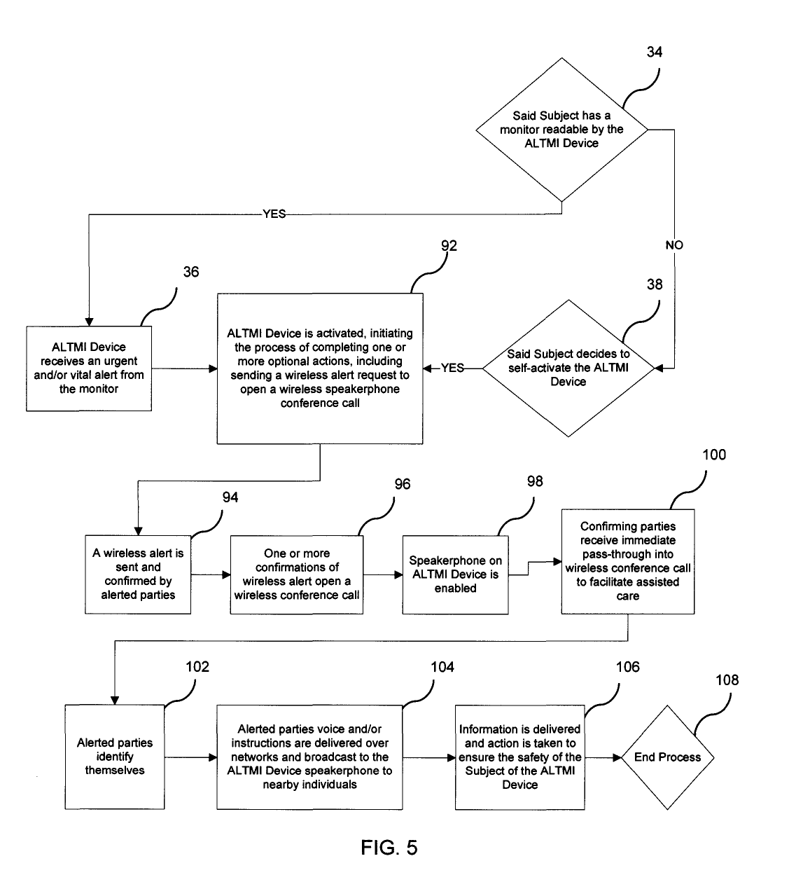

Referring now to FIG. 5, in another exemplary process carried out by the mobile emergency alert system, if the subject 14 has a medical monitor 12 that is readable by the ALTMI 16 (34), then the ALTMI 16 may receive an urgent and/or vital alert from the medical monitor 12 (36). If the medical monitor 12 is not readable by the ALTMI 16, then the subject 14 may self-activate the ALTMI 16 (38). Once the ALTMI 16 is activated, the ALTMI 16 will initiate one or more optional actions, including sending a wireless alert request to open a wireless speakerphone conference call (92). An alert is sent and confirmed by the alerted parties (94), which may include a representative of the service provider 26, the subject's 14 emergency contacts 28 and/or a telecare provider 30. One or more confirmations of the alert will open the wireless speakerphone conference call (96), and the speakerphone on the ALTMI 16 is enabled (98). Each of the confirming parties receives immediate access into the wireless conference call to facilitate assistance to or for the subject 14 (100). The alerted parties identify themselves (102) and provide information and instructions to each other, the subject 14 and any nearby individuals, which is broadcast to the ALTMI 16 speakerphone (104). The information and instructions are thus delivered and necessary actions are taken to ensure the safety and well-being of the subject 14 (106). For example, if the subject 14 has a critical event in the subject's backyard, and one of the emergency contacts 28, such as a spouse or child, is in the house, medical assistance may be administered very quickly. Further, the telecare provider 30 can guide the emergency contact 28 to provide the appropriate medical treatment. If the subject needed further assistance, such as transportation to a nearby medical facility or care by an EMT, the telecare provider 30 may direct the representative of the service provider 26 to have an ambulance dispatched. Because all the alerted parties are on a conference call, the necessary steps can be discussed and implemented quickly, without leaving the subject 14 or the conference call. Once the safety and well-being of the subject 14 has been ensured, the process is ended (108).

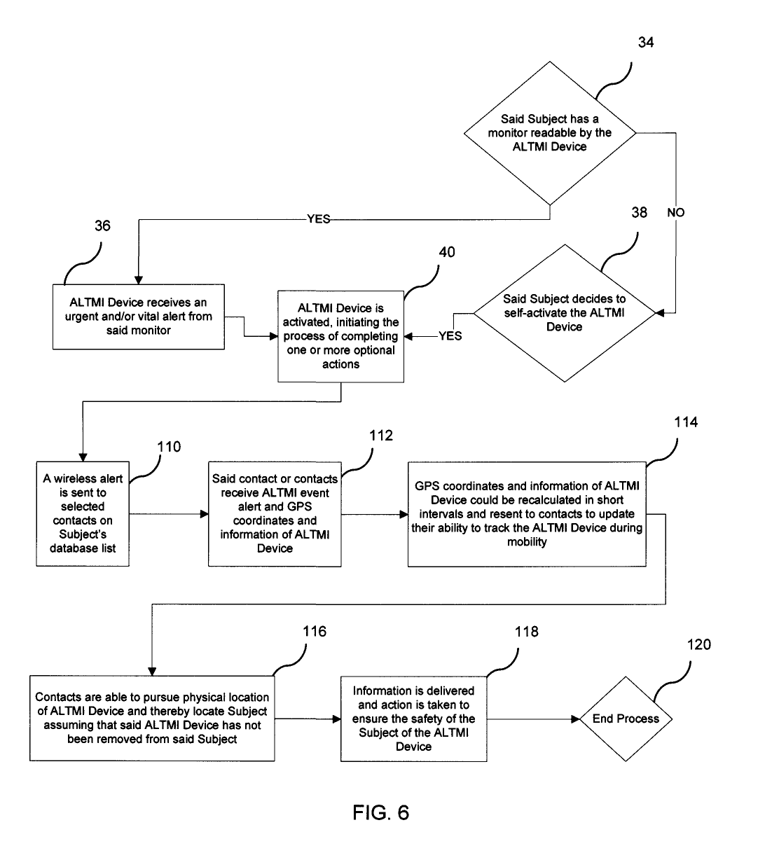

Referring now to FIG. 6, as described above, once the ALTMI 16 is activated, the ALTMI 16 will initiate one or more optional actions (40). One option may be to send a wireless alert to selected emergency contacts 28 from the subject's medical database 24 (110). The emergency contacts 28 may include one or more individuals. The selected emergency contacts 28 may be selected based on various criteria, such as, for example, the time of day, location, preference or expertise. For example, some emergency contacts 28 may be co-workers, and would be selected during business hours. Some emergency contacts may be neighbors, and would be selected for evening and overnight hours. Some emergency contacts may be selected when the subject 14 travels, as described above. The selected emergency contacts 28 receive an alert from the ALTMI 16 and various information, for example, location information, such as GPS 18 coordinates, and medical information (112). The location and medical information may be recalculated in short intervals and resent to the selected emergency contacts 28 to update the ability to track the ALTMI 16, and thus the subject 14, when the subject 14 is mobile (114). The selected emergency contacts 28 are thus able to pursue the real-time physical location of the subject 14 (116). Once the subject 14 has been located, the information is delivered and used as described above to ensure the safety of the subject 14 (118). Once the safety and well-being of the subject 14 has been ensured, the process is ended (120).

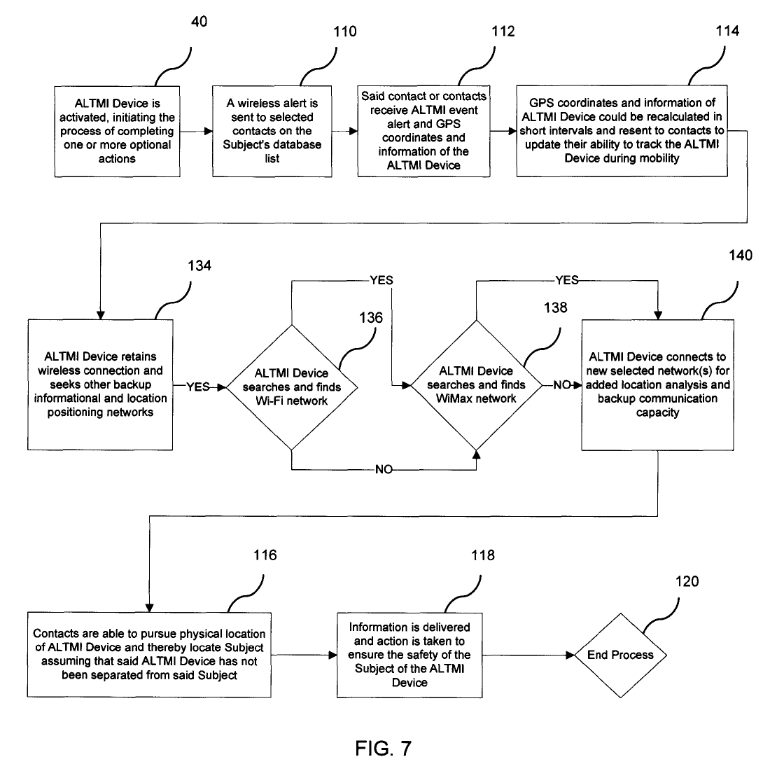

Referring now to FIGS. 6 and 7, as described above, once the ALTMI 16 is activated, the ALTMI 16 will initiate one or more optional actions (40), such as sending a wireless alert to selected emergency contacts 28 from the subject's medical database 24 (110). While the selected emergency contacts 28 receive the alert and various information from the ALTMI 16 (112 and 114), the ALTMI 16 retains the wireless connection, but seeks another backup network over which the information from the ALTMI 16 may be sent (134). For example, the ALTMI 16 may search for a Wi-Fi network (136) and/or a WiMax network (138). Once other networks are identified, the ALTMI 16 connects to newly selected networks for added location analysis and backup communication capacity (140).

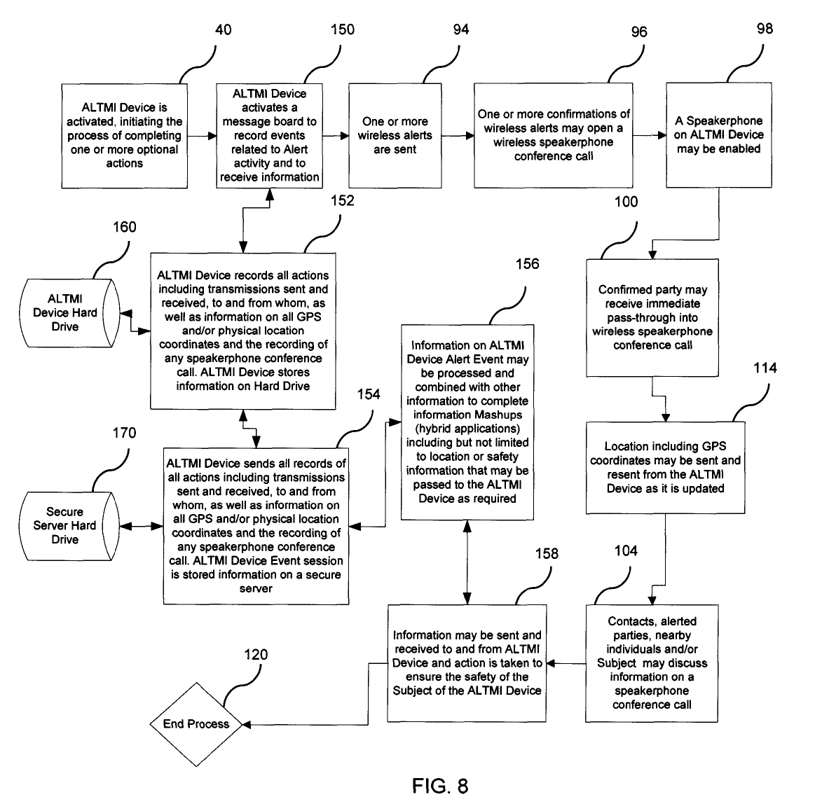

Referring now to FIG. 8, in addition to the various steps described above, the ALTMI 16 may activate a message board to record events related to the critical event and to receive information (150). The ALTMI 16 records all actions, which may include transmissions sent and received, all location information and a recording of any speakerphone conference calls (152), which is stored on the ALTMI 16 hard drive 160, or other electronic memory. The ALTMI 16 also forwards this data (154) to a secure server 170. Information regarding the critical event on the ALTMI 16 may be processed and combined with other information, for example from the telecare provider 30 or service provider 26, to complete informational mashups (hybrid applications), for example location or safety information that may be passed to the ALTMI 16 as required (156). For example, GPS coordinates of the subject and the emergency contacts could be combined with Google®-Earth™-style or Microsoft® Virtual Earth™-style GPS location technology so the call center screen will reflect the locations of the emergency contacts in relation to the subject 14. The information may be sent to and received from the ALTMI 16, and the appropriate action thereby may be implemented to ensure the safety of the subject 14 (158).

It is to be understood that the foregoing description is intended to illustrate and not to limit the scope of the invention, which is defined by the scope of the appended claims. Other embodiments are within the scope of the following claims. For example, while the ALTMI 16 has been described as a mobile telephone, the ALTMI 16 may be any other suitable two-way mobile communication device, such as a personal digital assistant (“PDA”). In such an example, if the PDA does not include voice capability, the representative of the service provider 26, the emergency contacts 28 and the telecare provider 30 may communicate with the subject 14 or those rendering aid to the subject through text messaging. Also, the ALTMI 16 may be any type of mobile telephone, such as a WiFi-enabled telephone or smartphone, or a dedicated two-way mobile communication device.

Further, while the medical monitor 12 is described as communicating with the ALTMI 16 by certain wireless technology, the medical monitor 12 may also communicate with the ALTMI 16 by any other wireless technology or by hardwire.

Further still, while the medical monitor 12 has been described as measuring a subject's physiological data related to a medical condition, the medical monitor 12 and ALTMI16 may be used by other individuals, including athletes who may wish to measure any physiological data, not just data related to a medical condition, to ensure the athlete's well-being.

Also, while many steps have been described, more or fewer steps may be performed by the mobile emergency alert system.

What is claimed is:

1. A mobile emergency alert system comprising:
at least one medical monitor to measure and collect physiological data of a subject;
a service provider including a database comprising medical records of the subject and an emergency contact list of the subject including at least one emergency contact; and
a two-way mobile communication device configured to communicate with the at least one medical monitor and the service provider, and configured to transmit the physiological data from the at least one medical monitor to the service provider and to receive information from the service provider and the emergency contacts through a conference line when a critical event is detected.

2. The mobile emergency alert system of claim 1 wherein the two-way mobile communication device further comprises a speaker and the conference line is a conference call.

3. The mobile emergency alert system of claim 1 wherein the two-way mobile communication device is configured to transmit the physiological data to the service provider and to receive a preliminary warning and one or more instructions from the service provider when an onset of the critical event is detected.

4. The mobile emergency alert system of claim 1 wherein the two-way mobile communication device is configured to enable the subject to initiate a transmission of the physiological data to the service provider and to receive information from the service provider and the emergency contacts through the conference line.

5. The mobile emergency alert system of claim 1 wherein the two-way mobile communication device is a mobile telephone configured to communicate with the at least one medical monitor.

6. The mobile emergency alert system of claim 5 wherein the two-way mobile communication device is a mobile telephone and a proxy device configured to facilitate communication between the mobile telephone and the at least one medical monitor.

7. The mobile emergency alert system of claim 1 wherein the medical records of the subject and emergency contact list of the subject may be modified by the subject.

8. The mobile emergency alert system of claim 7 wherein the medical records of the subject and emergency contact list of the subject are modified through an internet portal, mobile device, or call-in center.

9. The mobile emergency alert system of claim 1 wherein select emergency contacts are chosen from the emergency contact list based on specific criteria.

10. The mobile emergency alert system of claim 1 wherein the two-way mobile communication device further transmits a location coordinate of the subject.

11. The mobile emergency alert system of claim 10 wherein the location coordinate of the subject is selected from the group consisting of global positioning system coordinates and mobile telephone triangulation.

12. The mobile emergency alert system of claim 9 wherein the specific criteria is selected from the group consisting of proximity, time of day, priority and area of expertise.

13. The mobile emergency alert system of claim 1 wherein the two-way mobile communication device is configured to enable the subject to locate other subjects using a mobile emergency alert system.

14. The mobile emergency alert system of claim 13 wherein the other subjects using the mobile emergency alert system are located based on proximity and preferences.

15. A method of rendering aid to a subject comprising:
monitoring and collecting physiological data of the subject;
receiving the physiological data of the subject by a service provider, wherein the service provider maintains a database comprising medical records of the subject and an emergency contact list of the subject; and
initiating a conference call between the subject and at least one emergency contact from the emergency contact list when a critical event is detected.

16. The method of claim 15 wherein a two-way mobile communication device comprising a speaker transmits the physiological data of the subject to the service provider.

17. The method of claim 16 wherein the two-way mobile communication device is configured to transmit the physiological data to the service provider and receive a preliminary warning and instructions from the service provider when an onset of the critical event is detected.

18. The method of claim 15 wherein the subject initiates the transmission of the physiological data to the service provider.

19. The method of claim 16 wherein the conference call is broadcast over the speakerphone.

20. The method of claim 15 wherein the medical records of the subject and emergency contact list of the subject may be modified by the subject.

21. The mobile emergency alert system of claim 16 wherein the two-way mobile communication device further transmits a location coordinate of the subject to the service provider.

22. The method of claim 15 wherein select emergency contacts are chosen from the emergency contact list based on specific criteria.

23. The method of claim 16 wherein the two-way mobile communication device is a mobile telephone configured to communicate with at least one medical monitor for measuring the physiological data of the subject.

24. The method of claim 23 wherein the two-way mobile communication device is a mobile telephone and a proxy device configured to facilitate communication between the mobile telephone and the at least one medical monitor or sensor.
